(19) United States
(12) Patent Application Publication
(10) Pub. No.: US 2011/0086785 A1
(43) Pub. Date: Apr. 14, 2011

(54) GREASE COMPOSITION FOR AUTOMOBILE WHEEL BEARING

(75) Inventors: Kazunori KUBOTA, Iwata-shi (JP); Makoto OISHI, Fujisawa-shi (JP)

(73) Assignees: NTN CORPORATION, Osaka (JP); KYODO YUSHI CO., LTD., Tokyo (JP)

(21) Appl. No.: 12/970,572

(22) Filed: Dec. 16, 2010

Related U.S. Application Data
(63) Continuation of application No. 11/712,992, filed on Mar. 2, 2007, now abandoned.
Application No. 11/712,992 is a continuation of application No. PCT/JP2005/016401, filed on Sep. 7, 2005.

(30) Foreign Application Priority Data
Sep. 7, 2004 (JP) 2004-260170

(51) Int. Cl. F16C 33/00

(52) U.S. Cl. 508/108

(57) ABSTRACT

The present invention provides a grease composition for automobile wheel bearings, which contains (a) an urea thickener represented by general formula (1); R₁—NHCONH—R₂—NHCONH—R₃ (wherein R₁ and R₃ may be the same or different from each other and are each independently an aromatic hydrocarbon group having 6 to 12 carbon atoms, and R₂ represents an aromatic hydrocarbon group having 6 to 15 carbon atoms); (b) an organic molybdenum compound; and (c) a base oil. The composition of the present invention can extend the flaking life and lubrication life, and reduce the fretting wear.

### TECHNICAL FIELD

The present invention relates to a grease composition used for automobile wheel bearings.

### BACKGROUND ART

With respect to the automobile wheel bearings, the bearings support the vehicle's weight through the tires, and at the same time, they are operated under comparatively heavy load conditions with the application of radial, thrust and moment loads as well as impact loads from the contact point of the tires with ground depending upon the running conditions of the vehicle (non-patent document 1). This may often cause the problem of flaking as a result of metal fatigue. To extend the flaking life (i.e., fatigue life of the bearing material), a layer of lubricating oil is thickened (namely, by increasing the viscosity of the oil). However, satisfactory grease compositions have not yet been obtained.

Further, while the vehicle carries a freight car, the bearings are subject to slight vibration and the like and eventually worn out to cause a phenomenon called fretting in some cases. The solution to the fretting phenomenon conventionally lies in improvement of the lubricating properties by choosing a grease capable of forming a strong oil layer and showing excellent fluidity. However, there is no grease composition that can meet such requirements satisfactorily.

The grease composition will deteriorate due to oxidation and cannot exhibit its desired performance as the period of service of a car is prolonged or the mileage is accumulated. In light of this, the grease composition is required to extend its useful oxidation life (lubrication life).

In general, the wheel bearings for automobiles are roughly classified into two groups according to kinds of loads to be imposed on the bearings, that is, ball bearings (mainly used for passenger cars) and tapered roller bearings (mainly used for trucks). In the tapered roller bearings, when oil in the form of a layer runs out around the periphery of the rollers, the end portions of the rollers may be damaged while sliding. The damage mentioned above is commonly referred to as galling at the end of the rollers, and conventionally, some measures are taken against this problem, for example, by increasing the amount of oil, improving the extreme pressure performance of lubricants, and so on.

The automobile wheel bearings have gone through some generations in terms of their structure: bearings on their own (a pair of bearings that match the specified standards); first-generation bearings where two bearings are assembled into a unit; second-generation bearings where a hub shaft or a part of knuckle is incorporated; third-generation bearings where a hub wheel and a knuckle are incorporated; and fourth-generation bearings where the inner ring of a bearing and the outer ring of a constant velocity joint are integrated. The problems mentioned above are common to all the generations.

Non-patent Document 1: Society of Automobile Engineers of Japan, “Jidousha no Tribology (Tribology in Automobiles)” (YOKENDO Co., Ltd., Mar. 15, 1997): p. 270

### DISCLOSURE OF THE INVENTION

### Problems To Be Solved By the Invention

An object of the present invention is to provide a grease composition for wheel bearings of automobiles, which can extend the flaking life of automobile wheel bearings and exhibit prolonged lubrication life, with the fretting wear being reduced.

### Means For Solving the Problems

Accordingly, the present invention provides a grease composition for automobile wheel bearings, comprising:

(a) an urea thickener represented by the following general formula (1):

R₁—NHCONH—R2—NHCONH—R3 (1)

wherein R₁ and R₃ may be the same or different from each other and are each independently an aromatic hydrocarbon group having 6 to 12 carbon atoms, and R2 represents an aromatic hydrocarbon group having 6 to 15 carbon atoms;

(b) an organic molybdenum compound; and

(c) a base oil.

### Effects of the Invention

The grease of the present invention can significantly extend the flaking life of the wheel bearings in the automobiles and the lubrication life, and reduce the fretting wear. In particular, the grease of the present invention can extend the useful life of cars to 10 years and guarantee 1,200,000 kilometers of driving, for example, by preventing the galling at the end of the rollers in the tapered roller bearings.

### BEST MODE FOR CARRYING OUT THE INVENTION

### (a) Urea Thickener

The urea thickener usable in the present invention is a thickener with excellent heat resistance, which is represented by the following general formula:

R₁—NHCONH—R2—NHCONH—R3 (1)

In the above formula, R₁ and R₃ may be the same or different from each other and are each independently an aromatic hydrocarbon group having 6 to 12 carbon atoms. To be more specific, phenyl group, tolyl group, xylyl group, cumenyl group, t-butylphenyl group, benzyl group, mesityl group and the like can be employed. Particularly preferred is tolyl group.

In the formula, R2 represents an aromatic hydrocarbon group having 6 to 15 carbon atoms. Representative examples of R₂ are indicated by the following structural formulas:

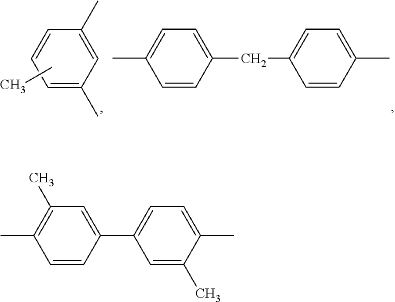

Specifically, urea compounds represented by the following formulas (1-1) and (1-2) can be used. Particularly preferred is the urea thickener represented by formula (1-1).

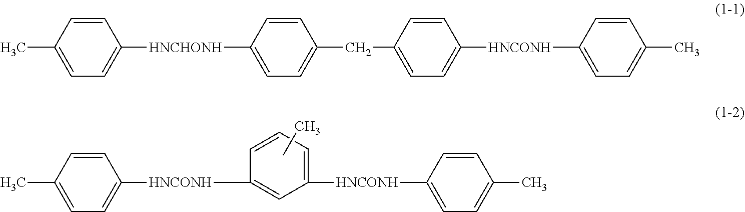

The content of the urea compound in the composition of the present invention is not particularly limited, but preferably in the range of 2 to 35% by mass with respect to the mass of the base oil.

The urea thickener used in the present invention is obtainable, for example, by reacting a monoamine with a diisocyanate at 10 to 200° C. The above-mentioned reaction process is not particularly limited and any conventional methods can be used. In the reaction, volatile solvents may be used. In this case, the solvents can be directly incorporated into the composition of the present invention if the solvents are usable for the base oil.

Specific examples of the diisocyanate include aromatic diisocyanates such as 2,4-tolylene diisocyanate, 2,6-tolylene diisocyanate, diphenylmethane-4,4′-diisocyanate, and naphthylene-1,5-diisocyanate, and mixtures thereof. Examples of the monoamine include aromatic amines such as aniline, benzylamine, toluidine, chloroaniline and the like.

The urea thickener mentioned above has a film-forming capability, so that the life of the bearings (in terms of flaking) can be increased and the fretting can be reduced, Moreover, unlike metallic soap thickeners, the above-mentioned urea thickener has no promoting effect on oxidation of the base oil, with the result that the oxidation life (i.e., lubrication life) of the grease can be extended.

### (b) Organic Molybdenum Compound

The organic molybdenum compounds herein used are generically referred to as organic metal-containing load carrying additives where molybdenum is used as a metal group, which are widely used as extreme pressure additives, in general. To be more specific, molybdenum dithiocarbamate (MoDTC), molybdenum dithiophosphate and the like can be used. In particular, MoDTC is preferred, and preferable examples of the MoDTC are represented by the following formula (2):

[R₄R₅N—CS—S]₂—Mo₂OₘSₙ (2)

wherein R₄ and R5, which may be the same or different and each independently represents a straight-chain or branched alkyl group having 1 to 24 carbon atoms, preferably 3 to 18 carbon atoms; and m ranges from 0 to 3 and n ranges from 4 to 1, provided that m+n=4.

The content of the organic molybdenum compound in the composition of the present invention is not particularly limited, but preferably in the range of 0.1 to 10% by mass, more preferably 1 to 5% by mass.

### (c) Base oil

The base oils usable in the present invention are those generally serving as lubricating oils with excellent stability at high temperatures and excellent fluidity at low temperatures. Although mineral oils as well as synthetic oils can be used as the base oils, preferably used is a mixed base oil where a synthetic oil component is contained in an amount of 20 to 50% by mass and a mineral oil component is contained in an amount of 80 to 50% by mass. Any of the conventionally known synthetic oils are usable, for example, poly(α-olefin) oils prepared from 1-decene as the starting material, co-oligomer oils of α-olefin and ethylene, phenyl ether based synthetic oils, ester based synthetic oils, polyglycol based synthetic oils, silicone oils and the like.

In particular, hydrocarbon oils consisting of carbon and hydrogen atoms are especially preferred as the synthetic oils.

When the mixed base oil includes a synthetic hydrocarbon oil as the synthetic oil component, sealing performance is not disadvantageously affected and leakage from the bearings can advantageously be reduced.

The grease composition of the present invention may further comprise an antioxidant, rust preventive, anticorrosive and the like, in addition to the above-mentioned components.

A preferable example of the composition according to the present invention comprises;

as the component (a), an urea thickener represented by the above-mentioned formula (1-1) or (1.2) in an amount of 10 to 25% by mass with respect to the total mass of the composition,

as the component (b), MoDTC in an amount of 1 to 5% by mass with respect to the total mass of the composition, and

as the component (c), a mixed base oil consisting of 60% of a mineral oil and 40% of a synthetic hydrocarbon oil, in particular, a poly(α-olefin) oil.

Particularly preferred is a composition wherein additives such as an antioxidant, a rust preventive and the like are added so that the amounts of the additives may be within the range of 1 to 10% by mass with respect to the total mass of the composition.

There is no limit to the production method for the composition of the present invention. Any conventional methods are usable. Specifically, the respective components may be added to a base oil simultaneously or successively and the resultant mixture may be kneaded using a roll mill or the like to prepare a composition. Alternatively, a combination of additives may be prepared so as to have a concentration of five to ten times that of the finished composition, and thereafter the combination of additives is mixed with a base oil to obtain a composition according to the present invention.

### EXAMPLE 1

The present invention will now be explained with reference to the following Examples and Comparative Examples.

Grease compositions according to Examples 1 to 4 and Comparative Examples 1 and 2 were independently prepared in such a manner that a thickener and an organic molybdenum compound were added to a base oil as shown in Table 1, and the resultant mixture was kneaded using a three-roll mill. The numerical values in Table 1 indicate the contents (%) in the composition. Examples 1 to 4 and Comparative Example 2 employed an aromatic urea compound represented by the previously mentioned formula (1-1) as the thickener. In each composition, an antioxidant and a rust preventive were incorporated as auxiliary components in amounts of 3% by mass and 2% by mass, respectively. The consistency of each grease composition was measured in accordance with JIS K2220. All the grease compositions were adjusted to have a consistency of 300.

TABLE 1

| | | | | | Comp. | Comp. |
|---|---|---|---|---|---|---|
| | Ex. 1 | Ex. 2 | Ex. 3 | Ex. 4 | Ex. 1 | Ex. 2 |
| (a) Thickener | Aromatic | Aromatic | Aromatic | Aromatic | Complex | Aromatic |
| | diurea | diurea | diurea | diurea | lithium | diurea |
| | 18 | 18 | 18 | 18 | soap | 18 |
| | | | | | 10 | |
| (b) MoDTC*¹ | 2 | 1 | 2 | 5 | 2 | — |
| (c) Base oil | | | | | | |
| Mineral oil | 100 | 80 | 60 | 50 | 60 | 60 |
| Synthetic | 0 | 20 | 40 | 50 | 40 | 40 |
| hydrocarbon oil | | | | | | |
| Flaking life | ◯ | ◯ | ◯ | ◯ | Δ | ◯ |
| Galling at | ⊚ | Δ | ⊚ | ⊚ | ◯ | X |
| end of rollers | | | | | | |
| Oxidation life | ◯ | ◯ | ⊚ | ⊚ | ◯ | ⊚ |
| (Lubrication | | | | | | |
| life) | | | | | | |
| Fretting | ⊚ | ⊚ | ⊚ | ⊚ | ◯ | ⊚ |

*¹Molyvan A, made by R.T. Vanderbilt Company, Inc.

The physical properties of the above-mentioned grease compositions were evaluated in accordance with the test methods shown below. The results obtained are also shown in Table 1.

### Life of Grease (In Terms of Flaking)

The life of grease was obtained as the flaking life by a rotational life test of a tapered roller bearing for use in large trucks. The results are expressed in terms of lifetime (hour).
Test conditions: Fr (radial load)=62.9 kN
   Fa (axial load)=25.2 kN
   N (Number of revolutions of bearing)=400 r/min,
   Radius of tire=517 mm
Evaluation criteria:
   ⊚: 700 hours or more
   ◯: 400 hours or more and less than 700 hours
   Δ: 200 hours or more and less than 400 hours
   ×: less than 200 hours

### Galling At End Portions of Rollers In Tapered Roller Bearing

In the test machine for rotational life of a tapered roller bearing designed for large trucks, the end portions of rollers in the bearing were observed. The results are expressed in terms of occurrence of galling and surface roughness. Test conditions: same as in the above-mentioned life test.
Evaluation criteria:
   ⊚: Neither galling, nor surface roughness
   ◯: Occurrence of surface roughness
   Δ: Occurrence of slight galling
   ×: Occurrence of galling

### Oxidation Life (Lubrication Life)

This item was obtained as a lubrication life of a deep groove ball bearing. The results are expressed in terms of lifetime (hour).
Test conditions: in accordance with ASTM D 3336
   Test temperature: 150° C.
   Number of revolutions: 10,000 rpm

Loads: Fa=Fr=67 N
Evaluation criteria:
   ⊚: 2500 hours or more
   ◯: 1000 hours or more and less than 2500 hours
   Δ: 200 hours or more and less than 1000 hours
   ×: less than 200 hours

### Fretting

The fretting wear was obtained in accordance with a Fafnir test. The results obtained are expressed in terms of abrasion amount.
Test conditions: in accordance with ASTM D 4170
   Test bearing: 51204)
   Period of test time: 2 hours
Evaluation criteria:
   ⊚: 0.5 mg or less
   ◯: more than 0.5 mg and 1.5 mg or less
   Δ: more than 1.5 mg and 2.5 mg or less
   ×: more than 2.5 mg

As is apparent from the results of Table 1, the grease compositions for automobile wheel bearings according to Examples are superior to those of Comparative Examples in that both the flaking life and the lubrication life are improved, the fretting wear is reduced, and galling at the end portions of rollers in the tapered roller bearings can be prevented.

1. A tapered roller bearing for an automobile wheel, wherein a grease composition comprising the following (a) to (c) is packed:
(a) an urea thickener represented by general formula (1):
R₁—NHCONH—R2—NHCONH—R3 (1)
wherein R₁ and R₃ may be the same or different from each other and each independently represents an aromatic hydrocarbon group having 6 to 12 carbon atoms, and R₂ represents an aromatic hydrocarbon group having 6 to 15 carbon atoms;
(b) 1 to 5% by mass of a molybdenum dithiocarbamate; and
(c) as a base oil, a mixture comprising 20 to 50% of a synthetic hydrocarbon oil and 80 to 50% of a mineral oil.

2. The tapered roller bearing of claim 1, wherein the urea thickener (a) is a compound represented by formula (1-1) or (1-2):

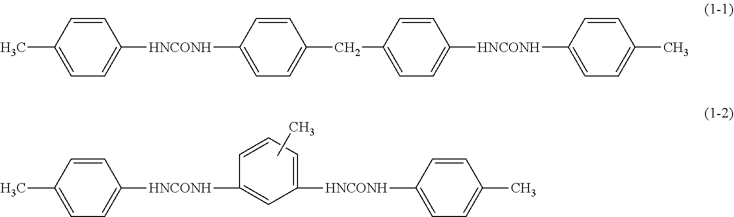

3. The tapered roller bearing of claim 1, wherein the urea thickener (a) is contained in an amount of 2 to 35% by mass with respect to the mass of the base oil.

4. (canceled)

5. The tapered roller bearing of claim 1, wherein the organic molybdenum compound (b) is a molybdenum dithiocarbamate represented by formula (2):
[R₄R₅N—CS—S]₂—Mo₂OₘSₙ (2)
wherein R₄ and R₅, which may be the same or different and each independently represents a straight-chain or branched alkyl group having 1 to 24 carbon atoms; and m ranges from 0 to 3 and n ranges from 4 to 1, provided that m+n=4.

6.-9. (canceled)

10. A tapered roller bearing for an automobile wheel, wherein a grease composition comprising the following (a) to (c) is packed:
(a) an urea thickener represented by formula (1-1) or (1-2) in an amount of 10 to 25% by mass with respect to the total mass of the composition; 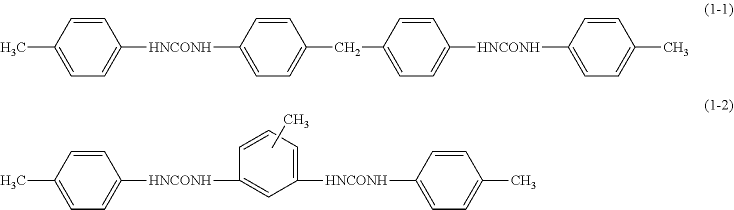
(b) a molybdenum dithiocarbamate in an amount of 1 to 5% by mass with respect to the total mass of the composition; and
(c) a mixed base oil consisting of 60% of a mineral oil and 40% of a synthetic hydrocarbon oil.

11. The tapered roller bearing of claim 1 wherein the bearing consists of two tapered roller bearings assembled into a single unit.

12. The tapered roller bearing of claim 10 wherein the bearing consists of two tapered roller bearings assembled into a single unit.
